(19) United States
(12) Patent Application Publication
(10) Pub. No.: US 2007/0194716 A1
(43) Pub. Date: Aug. 23, 2007

(54) Plasma display apparatus

(76) Inventors: Soo-Ho Park, Suwon-si (KR); Won-Ju Yi, Suwon-si (KR); Ho-Young Ahn, Suwon-si (KR); Kyoung-Doo Kang, Suwon-si (KR); Seok-Gyun Woo, Suwon-si (KR); Jae-Ik Kwon, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/708,485

(22) Filed: Feb. 21, 2007

(30) Foreign Application Priority Data
Feb. 23, 2006 (KR) 10-2006-0017887

(51) Int. Cl. H01J 17/49

(52) U.S. Cl. 313/582

(57) ABSTRACT

A plasma display apparatus including a front substrate and a rear substrate spaced a predetermined distance apart from each other and facing each other, a plurality of discharge spaces between the front and the rear substrates, a front discharge electrode and a rear discharge electrode corresponding to each discharge space, a phosphor layer corresponding to each discharge space, and a scattering field corresponding to each discharge space, the scattering field on an inside surface of the front substrate and facing the discharge space, the scattering field is configured to scatter visible light.

### BACKGROUND OF THE INVENTION

1. Field of the Invention

The present invention relates to a plasma display apparatus. More particularly, the present invention relates to a plasma display apparatus having an extended surface where discharge occurs and operates having an expanded viewing angle.

2. Description of the Related Art

Flat display devices employing plasma display panels (PDPs) have attracted considerable attention as the most promising next-generation flat display devices because they can be manufactured in a simplified manner. They also can be easily manufactured in large sizes compared to other flat display devices. Large flat display devices employing PDPs may provide large screens having certain advantages, such as providing high-quality image displays, very thin and light designs, and relatively wide viewing angles.

PDPs may be classified according to the discharge voltages applied to the discharge cells, such as direct current (DC) type, alternating current (AC) type, and hybrid type. PDPs may also be classified according to the configuration of the electrodes, such as facing-discharge type and surface-discharge type.

In DC-type PDPs, all of the electrodes may be exposed to a discharge space so that charges may move directly between facing electrodes. In AC-type PDPs, at least one of the electrodes may be covered by, for example, a dielectric layer. Also, in AC-type PDPs, discharge may be generated by an electrical field of wall charges instead of direct discharge between facing electrodes. Since charges move directly between facing electrodes in DC-type PDPs, the electrodes may be severely damaged. Accordingly, in recent years, AC-type PDPs, particularly, AC surface-discharge type PDPs having three-electrode structures, may be generally employed.

FIG. 1 illustrates a partial, exploded perspective view of a conventional AC surface-discharge type PDP having a three-electrode structure. As illustrated in FIG. 1, the PDP 100 may include an upper substrate 101 (also referred to as front substrate 101) and a lower substrate 102 (also referred to as a rear substrate 102) opposite to the upper substrate 101.

Address electrodes 103 may be formed on the rear substrate 102 and buried in a first dielectric layer 104. Barrier ribs 105 may be arranged on the first dielectric layer 104, thereby partitioning discharge spaces. A phosphor layer 110 may be formed in each of the discharge spaces. In addition to X electrodes 106, Y electrodes 107, and bus electrodes 108 for generating discharge, a second dielectric layer 109 and a protective layer 111 may also be formed on the front substrate 101. In this configuration, only about 60% of the visible light may be passed through the front substrate 101. Also, since the electrodes generating discharge are on the top sides of the discharge spaces, i.e., on an inside surface of the front substrate 101, they may reduce the amount of visible light passing through the front substrate 101. Therefore, the conventional AC surface-discharge type PDP 100 may operate with reduced luminous efficiency. Additionally, when the conventional AC surface-discharge type PDP 100 displays an image for a long period of time, charged particles of a discharge gas may be ion sputtered on the phosphor layers 110 due to an electrical field, so that image sticking or a permanent afterimage may occur. Furthermore, conventional flat display devices employing PDPs may not provide a wide or unrestricted viewing angle.

### SUMMARY OF THE INVENTION

The present invention is therefore directed to a plasma display apparatus that substantially overcomes one or more of the problems due to the limitations and disadvantages of the related art.

It is therefore a feature of an exemplary embodiment of the present invention to provide a plasma display apparatus that includes scattering fields which may provide an expanded viewing angle and may achieve an enhanced color display.

It is therefore another feature of an exemplary embodiment of the present invention to provide a plasma display apparatus that includes scattering fields which may significantly increase an aperture ratio of a front substrate and transmittance of visible light through the front substrate.

It is therefore another feature of an exemplary embodiment of the present invention to provide a plasma display apparatus having a discharge space structure which may significantly enhance luminous efficiency.

It is therefore another feature of an exemplary embodiment of the present invention to provide a plasma display apparatus having a discharge space structure which may reduce permanent image sticking.

It is therefore another feature of an exemplary embodiment of the present invention to provide a plasma display apparatus having an electrode arrangement which may operate with a low driving voltage.

It is therefore another feature of an exemplary embodiment of the present invention to provide a plasma display apparatus having an electrode arrangement which may operate with enhanced response to discharge and may be driven at a high speed.

At least one of the above and other features and advantages of the present invention may be realized by providing a plasma display apparatus which may include a front substrate and a rear substrate spaced a predetermined distance apart from each other and facing each other, a plurality of discharge spaces between the front and the rear substrates, a front discharge electrode and a rear discharge electrode corresponding to each discharge space, a phosphor layer corresponding to each discharge space, and a scattering field corresponding to each discharge space, the scattering field on an inside surface of the front substrate and facing the discharge space, the scattering field configured to scatter visible light.

The scattering field may have a predetermined curvature. The predetermined curvature may be concave with respect to the discharge space. The scattering field may include a rough surface.

The plasma display apparatus may further include a barrier structure that defines the plurality of discharge spaces, the front and the rear discharge electrodes may respectively surround each discharge space defined by the barrier structure.

The front discharge electrode may cross the rear discharge electrode.

The plasma display apparatus may further include an address electrode corresponding to each discharge space, and the front discharge electrode and the rear discharge electrode may form a ladder shape and extend substantially parallel to each other, and the address electrode may cross the front and the rear discharge electrodes.

The plasma display apparatus may further include another phosphor layer that covers the scattering field. The plasma display apparatus may further include sidewalls partitioning the space between the front and rear substrates into the plurality of discharge spaces.

The sidewalls may define only front portions of sides of the plurality of discharge spaces.

The plasma display apparatus may further include a rear dielectric layer between the phosphor layer and the address electrode, and the address electrode may be between the rear substrate and the phosphor layer.

Both the barrier structure and the sidewalls may define the plurality of discharge spaces, and the phosphor layer may have substantially the same height as a height of the barrier structure.

The front and the rear discharge electrodes may respectively surround each discharge space defined by the sidewalls.

At least one of the above and other features and advantages of the present invention may be realized by providing a plasma display apparatus which may include a first substrate and a second substrate, a plurality of discharge spaces between the first substrate and the second substrate, at least two electrodes corresponding to each discharge space, a phosphor layer corresponding to each discharge space, and a scattering field corresponding to each discharge space, the scattering field configured to scatter visible light generated by the phosphor layer.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a partial, exploded perspective view of a conventional AC surface-discharge type PDP having a three-electrode structure;

FIG. 2 illustrates a partial, exploded perspective view of a PDP, including an enlargement of a portion of the PDP, according to a first exemplary embodiment of the present invention;

FIG. 3A illustrates a partial, cross-sectional view taken along the line 3A-3A illustrated in FIG. 2;

FIG. 3B illustrates a perspective view of discharge electrodes illustrated in FIG. 3A;

FIG. 4 illustrates a partial, cross-sectional view of a PDP according to a second exemplary embodiment of the present invention;

FIGS. 5A through 5D illustrate cross-sectional views of a process in which discharge occurs in the discharge space illustrated in FIG. 2;

FIG. 6 illustrates a partial, cross-sectional view of a PDP according to a third exemplary embodiment of the present invention;

FIG. 7A illustrates a partial, cross-sectional view of a PDP according to a fourth exemplary embodiment of the present invention; and

FIG. 7B illustrates a perspective view of discharge electrodes illustrated in FIG. 7A.

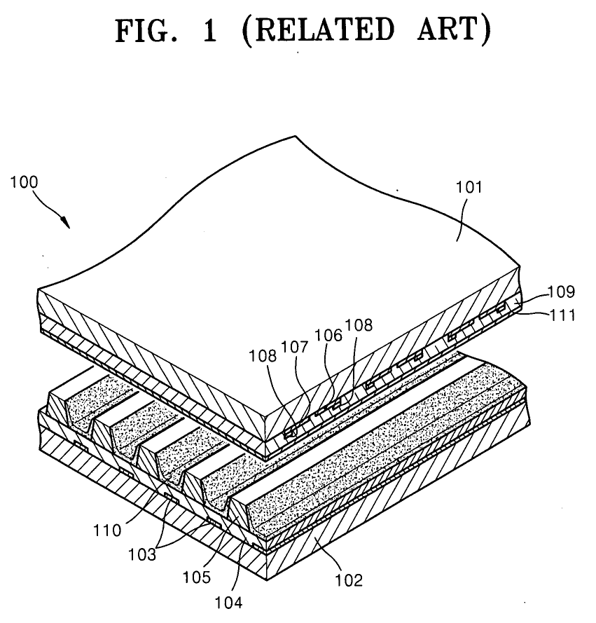

### DETAILED DESCRIPTION OF THE INVENTION

Korean Patent Application No. 10-2006-0017887, filed on Feb. 23, 2006, in the Korean Intellectual Property Office, and entitled: “Plasma Display Panel and Flat Display Device Employing the Plasma Display Panel,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the exemplary embodiments set forth herein. Rather, these exemplary embodiments are provided so that this disclosure will be thorough and complete, and will fully convey the scope of the invention to those skilled in the art.

In the figures, the dimensions of layers and regions may be exaggerated for clarity of illustration. It will also be understood that when a layer is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

The phrase “plasma display apparatus” is intended to be interpreted broadly, and encompass PDPs and plasma display devices employing PDPs.

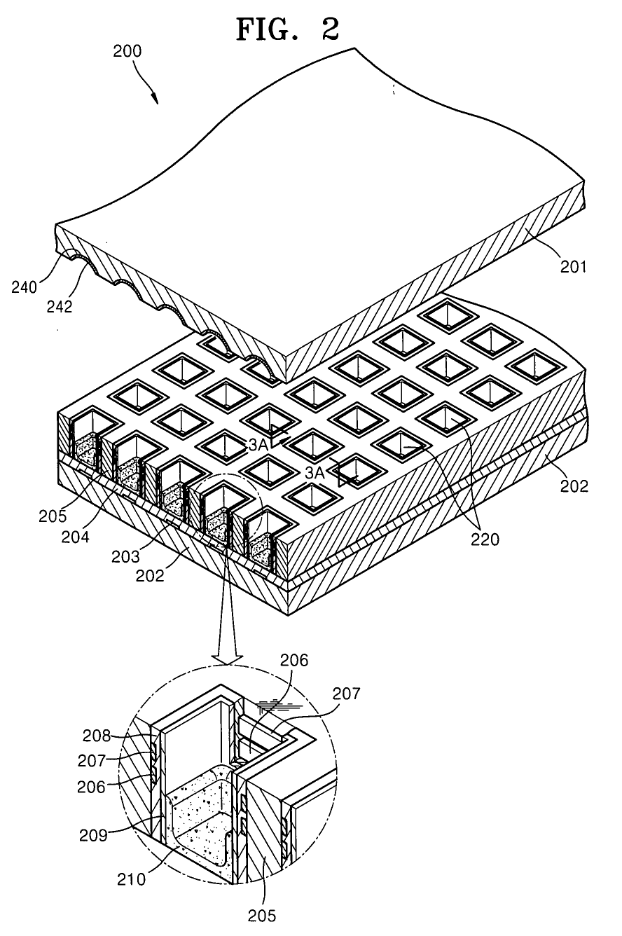

FIG. 2 illustrates a partial, exploded perspective view of a PDP, including an enlargement of a portion of the PDP, according to a first exemplary embodiment of the present invention. By reference, the term “front” denotes a direction in which an image is displayed by the PDP, and the term “rear” denotes a direction opposite to the direction in which an image is displayed by the PDP.

As illustrated in FIG. 2, the PDP 200 may include a front substrate 201 and a rear substrate 202. The front substrate 201 and the rear substrate 202 may be a predetermined distance apart from each other. The front substrate 201 and the rear substrate 202 may face each other. The front substrate 201 may be made of glass or any material that is transparent.

The PDP 200 may include a barrier structure 205. The barrier structure 205 may be disposed between the front substrate 201 and the rear substrate 202. The barrier structure may have a pattern to define a plurality of discharge spaces 220. In another implementation, the barrier structure 205 may have various patterns defining the plurality of discharge spaces 220. The barrier structure 205 may include an open barrier structure, such as strips, or a closed barrier structure, such as a waffle, a matrix, a delta, etc.

The horizontal cross-sections of the discharge spaces 220 may be rectangularly shaped, as illustrated in FIG. 2. In other implementations, the barrier structure 205 may also be formed so that horizontal cross-sections of the discharge spaces include, for example, a polygonal shape (e.g., triangular, quadrilateral, pentagonal, etc.), a circular shape, an oval shape, etc. The barrier structure 205 may serve both as an element that defines the discharge spaces 220 and a base on which discharge electrodes 206 and 207 may be provided. Hence, the barrier structure 205 may have a variety of suitable horizontal, cross-sectional shapes.

Address electrodes 203 facing the discharge spaces 220 may be arranged in a predetermined pattern, for example, in strips, on the rear substrate 202. In an exemplary operation, a voltage may be applied to the address electrodes 203 to select discharge spaces 220 where discharge is to be initiated. The pattern of the address electrodes 203 is not limited to the striped pattern illustrated in FIG. 2 and may vary according to the shape of the discharge spaces 220.

The address electrodes 203 may be on the rear substrate 202. In other implementations, the address electrodes may be disposed at other suitable places, such as on the front substrate 201 or in the barrier structure 205. Depending on the arrangement of the discharge electrodes 206 and 207, the address electrodes 203 may be unnecessary. For example, the discharge electrodes 206 and 207 may be arranged in a manner where they may cross each other. Thus, in an exemplary operation, a voltage may be applied to the front and rear discharge electrodes 206 and 207 so as to select the discharge spaces 220 where discharge is to be initiated. In this case, the address electrodes 203 may be unnecessary.

A rear dielectric layer 204 may be on the rear substrate 202 and may cover the address electrodes 203. In addition, although the barrier structure 205 is illustrated as being on the rear dielectric layer 204, other suitable arrangements exist. For example, the barrier structure 205 may be formed on the rear substrate 202, and the address electrodes 203 and the rear dielectric layer 204 may be sequentially formed on the front substrate 201 between sidewalls of the barrier structure 205.

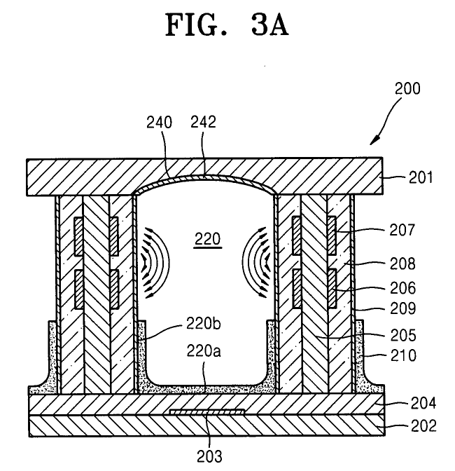

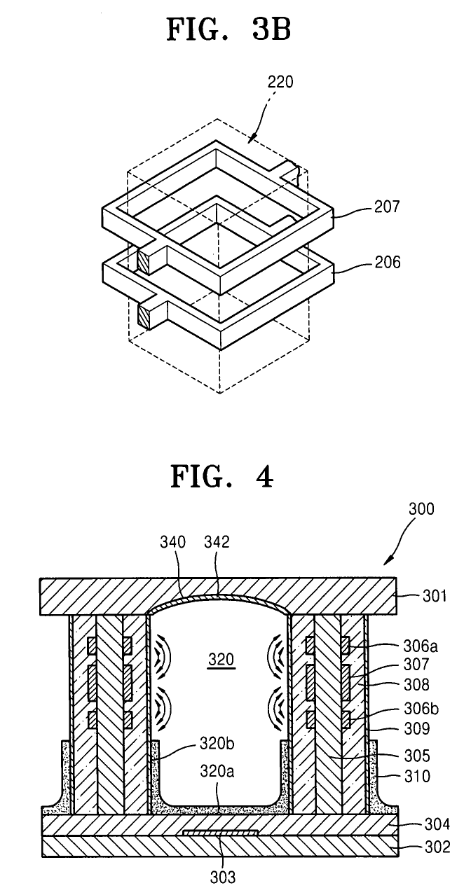

FIG. 3A illustrates a partial, cross-sectional view taken along the line 3A-3A illustrated in FIG. 2, and FIG. 3B illustrates a perspective view of discharge electrode 206, 207 of FIG. 3A. More particularly, FIG. 3A illustrates an exemplary arrangement of a discharge space 220 of the first exemplary embodiment of the PDP 200. It is to be understood that the arrangement of the discharge space 220 illustrated in FIGS. 3A and 3B may be replicated among the plurality of discharge spaces of the PDP 200 illustrated in FIG. 2. Further, it is to be understood that the discharge spaces illustrated in FIGS. 4, 6 and 7 may be replicated among the plurality of discharge spaces of the PDPs illustrated in FIGS. 4, 6 and 7.

Referring to FIGS. 3A and 3B, the front discharge electrode 207 (which may be, e.g., an X electrode) and the rear discharge electrode 206 (which may be, e.g., a Y electrode) may be on the barrier structure 205. The front discharge electrode 207 and the rear discharge electrode 206 may be aligned vertically between the front and the rear substrates 201 and 202. The front discharge electrode 207 and the rear discharge electrode 206 may be spaced apart from each other at predetermined intervals. For example, the front and rear discharge electrodes 207 and 206 may be substantially parallel to each other and arranged to have a shape of a ladder. In an exemplary operation, a discharge generated by an AC voltage applied to the front and the rear discharge electrodes 207 and 206 may be kept in the discharge space 220.

The front discharge electrode 207 and the rear discharge electrode 206 may have rectangular block shapes; however, they are not limited to this shape. Although not illustrated, the front and rear discharge electrodes 206 and 207 may have various other shapes, such as cylindrical shapes. Further, the front and rear discharge electrodes 206 and 207 may have different shapes from one another. Additionally, the front discharge electrode 207 and the rear discharge electrode 206 may be on the barrier structure 205; however, they may be disposed elsewhere, such as in the barrier structure. Accordingly, the front discharge electrode 207 and the rear discharge electrode 206 may have any number of suitable shapes and may be disposed elsewhere.

As illustrated in FIGS. 3A and 3B, the front discharge electrode 207 and the rear discharge electrode 206 may be formed around the sidewalls of the barrier structure 205, in parallel, so as to have ring shapes from a plan view. The front discharge electrode 207 and the rear discharge electrode 206 may be separated by a distance such that discharge generated by the application of, for example, an AC voltage, may be maintained. The distance between the front and rear discharge electrodes 206 and 207 may be shortened as much as possible in order to operate the PDP 200 with a low driving voltage. Although the front discharge electrode 207 and the rear discharge electrode 206 may be arranged differently, and may have different shapes, it may be preferable to arrange them so that discharge can easily be initiated even when a low driving voltage is applied and that the discharge can easily spread in the discharge space 220.

The front discharge electrode 207 and the rear discharge electrode 206 may be arranged so as to be insulated from each other. For example, a lateral dielectric layer 208 may exist between the front discharge electrode 207 and the rear discharge electrode 206. The lateral dielectric layer 208 may be on the barrier structure 205 and may cover the front and rear discharge electrodes 207 and 206.

A scattering field 240 for scattering visible light may be on an inside surface of the front substrate 201 that faces the discharge space 220. The scattering field 240 may have a predetermined curvature, such as a concave shape. That is, the scattering field 240 may have a surface facing the discharge space 220 that is concave. The curvature of the scattering field 240 may be determined in consideration of the angles at which visible light emitted from the discharge space 220 may be scattered. The scattering field 240 may have a rough surface. The scattering field 240 may be processed by one of sandblasting, chemical etching, laser processing, etc., in order to form the rough surface. The scattering field 240 may be formed from the front substrate 201 or may be a separate layer. A second phosphor layer 242 may be on the surface of the scattering field 240.

A layer 209 for protecting the lateral dielectric layer 208 may be on the lateral dielectric layer 208. The layer 209 may be made of, for example, an MgO layer.

A first phosphor layer 210 may be in the discharge space 220. In this implementation, the discharge space 220 may be defined by the protective layer 209, the rear dielectric layer 204, and the second phosphor layer 242. The first phosphor layer 210 may be on any portion of the discharge space 220; however, it may be preferable to have the first phosphor layer 210 cover a bottom surface 220a of the discharge space 220 and a lower portion of lateral surfaces 220b of the discharge space 220, as illustrated in FIG. 3A. In an exemplary operation, the first phosphor layer 210 may be excited by ultraviolet light and may emit visible light.

The discharge space 220 may be filled with a discharge gas, e.g., Ne, Xe, mixture thereof, etc.

The upper portion of the discharge space 220 may be enclosed by the front substrate 201. In contrast to the front substrate of other PDPs, no indium tin oxide (ITO) discharge electrodes, bus electrodes, and/or dielectric layer covering the electrodes need exist on the front substrate 201. Hence, according to the present invention, including this first exemplary embodiment, the aperture ratio of the front substrate 201 may be significantly improved, and the transmittance of visible light may be improved to approximately 90%. As a result, the PDP 200 may be operated with a reduced driving voltage. Further, the PDP 200 may be operated with enhanced luminous efficiency.

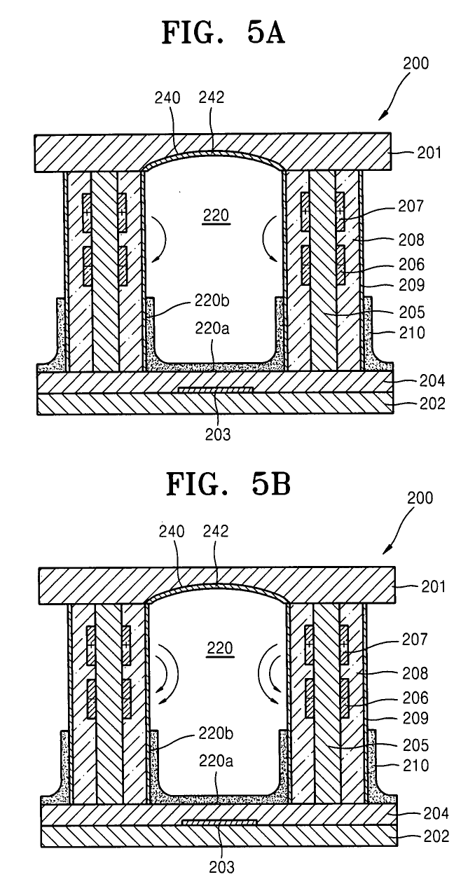

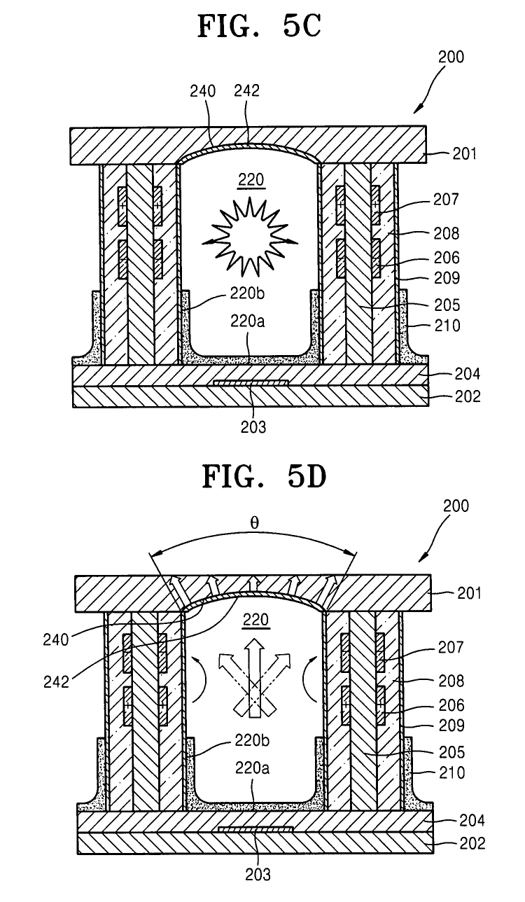

An exemplary discharging process of the PDP 200 illustrated in FIG. 3A will be discussed with reference to FIGS. 5A through 5D. While FIGS. 5A through 5D illustrate a single discharge space 220, it is to be understood that like processes as discussed herein may also occur among discharge spaces 220 of like arrangement of the PDP 200 of the first exemplary embodiment.

When an address voltage is applied from an external power source between the address electrode 203 and the rear discharge electrode 206, a discharge space 220 for emitting light may be selected, and wall charges may be accumulated on the rear discharge electrode 206 associated with the selected discharge space 220. Then, as illustrated in FIG. 5A, a voltage, e.g., positive voltage, may be applied to the front discharge electrode 207 associated with the selected discharge space 220, and another voltage, e.g., a voltage lower than the positive voltage may be applied to the rear discharge electrode 206, such that wall charges may be moved due to a difference between the two voltages applied. That is, wall charges may be moved due to the difference in voltages between the front discharge electrode 207 and the rear discharge electrode 206. Subsequently, the moving wall charges may collide with discharge gas atoms within the selected discharge space 220, and discharge may be initiated.

The discharge may begin in an area between the front and the rear discharge electrodes 207 and 206, where a relatively strong electrical field may be formed. In the first exemplary embodiment, the area between the front and rear discharge electrodes 207 and 206 may exist on the lateral surfaces of the discharge space 220. Hence, the probability that discharge will be generated may be increased as compared to other PDPs in which the area between discharge electrodes exists only on the upper surface of the discharge space.

Referring to FIG. 5B, when the difference between the voltages of the front and rear discharge electrodes 207 and 206 is maintained for a period of time, a strong electrical field may be formed between surfaces of the front and rear discharge electrodes 207 and 206 so that the discharge may spread through the entire area of the discharge space 220. That is, the discharge may begin in the ring shape on the four lateral surfaces of the discharge space 220 and then spread to the center thereof. This is in contrast to the discharge in the conventional art, where discharge may begin from only the upper surface of the discharge space 220 and then spread to the center thereof.

Accordingly, the discharge that may occur in the PDP 200 of the present invention may spread in a significantly wider range than that of the discharge that may occur in a PDP of the conventional art. Furthermore, plasma may be produced in the ring shape on the four lateral surfaces of the discharge space 220 due to the discharge and may spread to the center thereof. Thus, the volume of the plasma may be significantly increased, and the amount of visible light generated may be significantly enhanced.

Additionally, as the plasma collects at the center of the discharge space 220, spatial charges may be utilized so that the PDP may be operated with a low driving voltage and improved luminous efficiency. Further, as the plasma collects at the center of the discharge space 220, wall charges may be collected at the center of the discharge space 220, which may prevent ion sputtering of the first phosphor layer 210. As illustrated in FIG. 5C, the discharge spreading in the center of the discharge space 220 may generate ultraviolet light. The generated ultraviolet light may impinge the first phosphor layer 210 and generate visible light.

As illustrated in FIG. 5D, the generated visible light may pass through the front substrate 201. A portion of the visible light that is generated by the first phosphor layer 210 that is on the rear dielectric layer 204 may propagate through the depth of the discharge space 220 so as to be emitted through the front substrate 201. During this process, however, a remaining portion of the visible light may not be emitted because a depth of the discharge space 220 may be, e.g., equal to or greater than about 200 micrometers, and a height of the first phosphor layer 210 may be, e.g., equal to or greater than about 30 micrometers. That is, an efficiency of visible light emitted through the front substrate 201 may be poor. To improve the efficiency of visible light emitted through the front substrate 201, the scattering field 240 may have the predetermined curvature that faces the discharge space 220. Accordingly, the visible light indicated by the arrow within the discharge space 220 may be scattered by the scattering field 240 and emitted through the front substrate 201.

Since the predetermined curvature of the scattering field 240 may be concave, the visible light may be emitted at a viewing angle (θ). The viewing angle (θ) may correspond to the predetermined curvature of the scattering field 240. Hence, the viewing angle of the visible light may be significantly widened as compared to the case where no scattering field 240 exists.

As further illustrated in FIG. 5D, when the difference between the voltages of the front and rear discharge electrodes 207 and 206 becomes lower than a discharge voltage, the discharge may no longer be generated. Accordingly, spatial charges and wall charges may be formed within the discharge space 220. To counteract this occurrence, the polarities of the voltages applied to the front and rear discharge electrodes 207 and 206 may be changed so that initial discharge may be re-generated with the assistance of the wall charges. Thereafter, as illustrated in FIGS. 5A through 5C, the discharge may spread through the entire area of the discharge space 220.

Accordingly, when the polarities of the voltages applied to the front and rear discharge electrodes 207 and 206 are re-exchanged, the initial discharge process may be repeated again. By repeating these processes, the discharge may be generated in a stable manner in the discharge space 220. In an exemplary operation, an AC voltage may be respectively applied to the front and rear discharge electrodes 207 and 206. It is to be understood, however, the present invention is not limited to this type of discharge voltage. Additionally, the present invention is not limited to this type of discharge, but various other types of discharge within the range understandable by one of ordinary skill in the art to which the present invention pertains may be generated in the present invention.

FIG. 4 illustrates a partial, cross-sectional view of a PDP according to a second exemplary embodiment of the present invention. Elements of FIG. 3A indicated by reference numerals between 200 and 299 are, in turn, indicated by reference numerals between 300 and 399 in FIG. 4. Thus, elements illustrated in FIG. 4 that are redundant to those illustrated in FIG. 3A will not be described again herein.

Referring to FIG. 4, in order to widen as much as possible an area where discharge may occur, rear discharge electrodes 306a and 306b (which may be, e.g., Y electrodes) may be vertically aligned with front discharge electrode 307 (which may be, e.g., an X electrode). That is, the discharge electrode 306a may be located to the front of the discharge electrode 307, and the discharge electrode 306b may be located to the rear of the discharge electrode 307. By arranging the discharge electrode 307 and the discharge electrodes 306a and 306b in this exemplary manner, an area where discharge occurs may be expanded in the height direction of a discharge space 320, as indicated by the bi-directional arrows illustrated in FIG. 4. In this second exemplary embodiment, the discharge electrode 306b may be disposed close to the address electrode 303 in order to lower an address voltage applied between the address electrode 303 and the discharge electrode 306b.

A first phosphor layer 310 may cover a bottom surface 320a of the discharge space 320 and a lower portion of lateral surfaces 320b of the discharge space 320. A scattering field 340 for scattering visible light may be on an inside surface of a front substrate 301 that faces the discharge space 320. The scattering field 340 may have a predetermined curvature, such as a concave shape. The scattering field 340 may have a rough surface. A second phosphor layer 342 may also be on the scattering field 340.

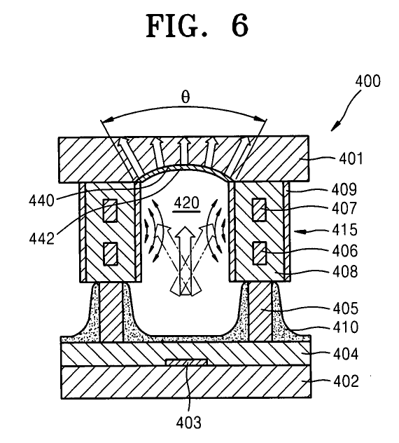

FIG. 6 illustrates a partial, cross-section view of a PDP according to a third exemplary embodiment of the present invention. Referring to FIG. 6, a front discharge electrode 407 (which may be, e.g., an X electrode) and a rear discharge electrode 406 (which may be, e.g., a Y electrode) may not be on or in a barrier structure 405. Rather, the front and rear discharge electrodes 407 and 406 may be disposed to the front of the barrier structure 405. That is, the front and rear discharge electrodes 407 and 406 may be between the barrier structure 405 and a front substrate 401. The discharge space 420 may be partially defined not only by the barrier structure 405 but also by the dielectric sidewalls 415. The dielectric sidewalls 415 may be to the front of the barrier structure 405 and on the barrier structure 405.

Dielectric sidewalls 415 may include dielectric layers 408. The front and rear discharge electrodes 407 and 406 may be arranged one over another and buried in the dielectric layers 408. Protective layers 409 may be on the dielectric layers 408. The dielectric sidewalls 415 may extend from the barrier structure 405. The dielectric sidewalls 415 may extend from the front substrate 401 and to the barrier structure 405.

The front and rear discharge electrodes 407 and 406 may be spaced apart from each other at predetermined intervals within the dielectric sidewalls 415. For example, the front and rear discharge electrodes 407 and 406 may be substantially parallel to each other and arranged to have a shape of a ladder. The front and the rear discharge electrodes 407 and 408 may have rectangular block shapes; however, they are not limited to this shape. An address electrode 403, which may intersect the front and rear discharge electrodes 407 and 406, may be on an inside surface of a rear substrate 402. The address electrode 403 may be buried in a rear dielectric layer 404. The lateral surfaces of the barrier structure 405 may be coated with a first phosphor layer 410. The first phosphor layer 410 may have the same height as a height of the barrier structure 405 and may be on an inside surface of the rear dielectric layer 404.

A scattering field 440 for scattering visible light may be on an inside surface of the front substrate 401 that faces the discharge space 420. The scattering field 440 may have a predetermined curvature, such as a concave shape. The scattering field 440 may have a rough surface. A second phosphor layer 442 may be on the scattering field 440.

According to the third exemplary embodiment, when discharge occurs within the discharge space 420 and visible light is emitted through the front substrate 401, the visible light may be scattered by the scattering field 440 so that a wide viewing angle (θ) may be achieved.

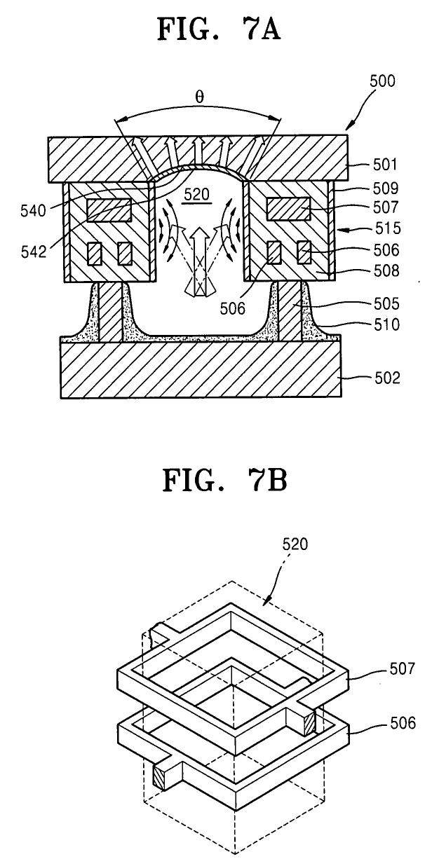

FIG. 7A illustrates a partial, cross-sectional view of a PDP according to a fourth exemplary embodiment of the present invention. Address electrodes may be omitted in the fourth exemplary embodiment of the PDP 500 illustrated in FIG. 7A. FIG. 7B illustrates a perspective view of discharge electrodes of FIG. 7A.

Referring to FIGS. 7A and 7B, a front discharge electrode 507 (which may be, e.g., an X electrode) and rear discharge electrodes 506 (which may be, e.g., Y electrodes) may not be located on or in a barrier structure 505. Rather, the front and rear discharge electrodes 507 and 506 may be disposed to the front of the barrier structure 505. That is, the front and rear discharge electrodes 507 and 506 may be between the barrier structure 505 and a front substrate 501. Thus, a discharge space 520 may be partially defined not only by the barrier structure 505 but also by dielectric sidewalls 515. The dielectric sidewalls 515 may be to the front of the barrier structure 505 and on the barrier structure 505.

The dielectric sidewalls 515 may include dielectric layers 508. The front and rear discharge electrodes 507 and 506 may be arranged so that the front discharge electrode 507 is to the front of the rear discharge electrodes 506. The front and rear discharge electrodes 507 and 506 may be buried in the dielectric layers 508. Protective layers 509 may cover the dielectric layers 508. The dielectric sidewalls 515 may extend from the barrier structure 505. The dielectric sidewalls 515 may extend from the front substrate 501 and to the barrier structure 505.

In the PDP 500, the front discharge electrodes 507 may be spaced apart from one another at regular intervals within the dielectric sidewalls 515 and may extend and cross the rear discharge electrodes 506 which may extend as well. Hence, a discharge space 520 where discharge is to occur may be selected without address electrodes. The lateral surfaces of the barrier structure 505 may be coated with a first phosphor layer 510. The first phosphor layer 510 may have the same height as a height of the barrier structure 505 and may be on the upper surface of the rear substrate 502.

A scattering field 540 for scattering visible light may be an inside surface of the front substrate 501 that faces the discharge space 520. The scattering field 540 may have a predetermined curvature, such as a concave shape. The scattering field 540 may have a rough surface. A second phosphor layer 542 may be on the scattering field 540.

According to the fourth exemplary embodiment, when discharge occurs within the discharge space 520 and visible light is emitted through the front substrate 501, the visible light may be scattered by the scattering field 540, so that a wide viewing angle (θ) may be achieved.

The elements other than those already discussed above may be similar to those of the PDP 200 and the PDP 400.

A PDP according to the present invention may offer a variety of advantages. Since scattering fields may be on a front substrate, visible light may pass through the front substrate in an expanded fashion. Thus, a viewing angle of the PDP may be significantly widened. Also, since the visible light passing through the scattering fields may afford a wider viewing angle, any difference of visible light emitted from adjacent discharge spaces may be significantly reduced. Accordingly, the plasma display apparatus of the present invention may provide an enhanced color display.

Additionally, an aperture ratio of the front substrate and the transmittance of visible light may be significantly increased. Also, an area of a discharge space where discharge initiates and occurs may be significantly increased. Thus, plasma may be collected at the center of the discharge space, and luminous efficiency may be significantly improved. Even when a highly concentrated gas, such as Xe gas, is used as a discharge gas, the PDP may be operated with a low driving voltage and enhanced luminous efficiency. Further, the plasma display apparatus of the present invention may respond afford enhanced response to discharge and may prevent permanent image sticking.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display apparatus, comprising:
a front substrate and a rear substrate spaced a predetermined distance apart from each other and facing each other;
a plurality of discharge spaces between the front and the rear substrates;
a front discharge electrode and a rear discharge electrode corresponding to each discharge space;
a phosphor layer corresponding to each discharge space; and
a scattering field corresponding to each discharge space, the scattering field on an inside surface of the front substrate and facing the discharge space, the scattering field configured to scatter visible light.

2. The plasma display apparatus as claimed in claim 1, wherein the scattering field has a predetermined curvature.

3. The plasma display apparatus as claimed in claim 2, wherein the predetermined curvature is concave with respect to the discharge space.

4. The plasma display apparatus as claimed in claim 1, wherein the scattering field includes a rough surface.

5. The plasma display apparatus as claimed in claim 1, further comprising a barrier structure that defines the plurality of discharge spaces, wherein the front and the rear discharge electrodes respectively surround each discharge space defined by the barrier structure.

6. The plasma display apparatus as claimed in claim 1, wherein the front discharge electrode crosses the rear discharge electrode.

7. The plasma display apparatus as claimed in claim 1, further comprising:
an address electrode corresponding to each discharge space,
wherein the front discharge electrode and the rear discharge electrode form a ladder shape and extend substantially parallel to each other, and the address electrode crosses the front and the rear discharge electrodes.

8. The plasma display apparatus as claimed in claim 1, further comprising another phosphor layer covering the scattering field.

9. The plasma display apparatus as claimed in claim 1, further comprising sidewalls partitioning the space between the front and rear substrates into the plurality of discharge spaces.

10. The plasma display apparatus as claimed in claim 9, wherein the scattering field has a predetermined curvature.

11. The plasma display apparatus as claimed in claim 10, wherein the predetermined curvature is concave with respect to the discharge space.

12. The plasma display apparatus as claimed in claim 9, wherein the scattering field includes a rough surface.

13. The plasma display apparatus as claimed in claim 9, wherein the sidewalls define only front portions of sides of the plurality of discharge spaces.

14. The plasma display apparatus as claimed in claim 9, further comprising another phosphor layer covering the scattering field.

15. The plasma display apparatus as claimed in claim 9, wherein the front discharge electrode crosses the rear discharge electrode.

16. The plasma display apparatus as claimed in claim 9, further comprising:
an address electrode corresponding to each discharge space,
wherein the front discharge electrode and the rear discharge electrode form a ladder shape and extend substantially parallel to each other, and the address electrode crosses the front and the rear discharge electrodes.

17. The plasma display apparatus as claimed in claim 16, further comprising:
a rear dielectric layer between the phosphor layer and the address electrode,
wherein the address electrode is between the rear substrate and the phosphor layer.

18. The plasma display apparatus as claimed in claim 9, further comprising:
a barrier structure, wherein both the barrier structure and the sidewalls define the plurality of discharge spaces,
wherein the phosphor layer has substantially the same height as a height of the barrier structure.

19. The plasma display apparatus as claimed in claim 9, wherein the front and the rear discharge electrodes respectively surround each discharge space defined by the sidewalls.

20. A plasma display apparatus, comprising:
a first substrate and a second substrate;
a plurality of discharge spaces between the first substrate and the second substrate;
at least two electrodes corresponding to each discharge space;
a phosphor layer corresponding to each discharge space; and
a scattering field corresponding to each discharge space, the scattering field configured to scatter visible light generated by the phosphor layer.
